(19) United States
(12) Patent Application Publication
(10) Pub. No.: US 2008/0183582 A1
(43) Pub. Date: Jul. 31, 2008

(54) Advertisement System and Method of Doing Business

(76) Inventor: Mark L. Major, Santa Clara, CA (US)

Correspondence Address: CENTRAL COAST PATENT AGENCY, INC, 3 HANGAR WAY SUITE D, WATSONVILLE, CA, 95076, US

(21) Appl. No.: 12/020,004

(22) Filed: Jan. 25, 2008

Related U.S. Application Data
(60) Provisional application No. 60/897,704, filed on Jan. 26, 2007.

(51) Int. Cl. G06Q 30/00

(52) U.S. Cl. 705/14

(57) ABSTRACT

A system for passive display of advertisements served from a network includes a computing device having a processor and memory connected to the network, a primary graphics display screen on the computing device, and a secondary graphics display screen connected to a port on the computing device, the secondary display screen dedicated for displaying the advertisements. The advertisements are served to the computing device along with other network data downloaded for primary display by the device as a result of network activity by the computing device and wherein the advertisements served are displayed on the secondary graphics display screen and not on the primary graphics display screen.

### CROSS-REFERENCE TO RELATED APPLICATIONS

The present invention claims priority to a U.S. provisional patent application Ser. No. 60/897,704 entitled “ADVERTISEMENT SYSTEM AND METHOD OF BUSINESS” filed on Jan. 26, 2007, disclosure of which is incorporated herein in its entirety at least by reference.

### BACKGROUND OF THE INVENTION

1. Field of the Invention

The present invention is in the field of electronic advertising including Web-based banner advertising and pertains particularly to a system and methods for passive electronic advertising to peripheral display screens.

2. Discussion of the State of the Art

In the field of advertising, passive advertising generally defines advertising that is presented to the public in a way that does not require any action from the viewer or target of the advertisement. The advertiser hopes that a portion of the audience that sees the advertisement will contact the business responsible for the advertisement and patronize that business. Print and media advertising are forms of passive advertising that target users who read the advertisements in a publication or see them on a television while viewing programming. Other forms of passive advertising include billboard advertising targeting traffic, store front advertising targeting shoppers, and radio advertising.

Advertisers routinely pay for ad space or spots depending on the media form to get their advertisements in front of an audience. Generally speaking, the larger the audience, the more expensive the ad space or spot is. Web pages are vehicles for spot advertising via banner ads, pop-up ads, and “click through” ads. Electronic ads can be static ads or ads that are served in same place holder every time a Web page is loaded into a browser. Other ads like pop-up ads are served when the browser reads a script or if a user clicks on a link in a Web page.

Web advertising is sometimes tailored to the activities of users and whatever data is known or can be found out about a user. Personalized advertising seeks to deliver ads that a user may be more inclined to interact with based on information known about the user. Location of the user is another consideration for advertisers. Location-based advertising is used with mobile system that have active GPS installed. Advertising relevant to a user's location at the time of ad service may produce more ad response than random advertising for example.

One problem with Web-based advertising whether behavioral-based, location-based or other is that users who are targets of the advertisement are often miffed by the amount of advertising they must endure in order to browse the Internet. Pop-up blocker software is often employed by users to block advertising. Advertisers continue to develop ways to deliver advertising in ways that do not irritate users. Consumers also develop ways to navigate without being troubled by unsolicited advertising.

What is clearly needed is a system for delivering Web-based advertising to potential consumers in a way that does not interfere or otherwise tax a user navigating the Internet but that instead targets passersby instead of the users themselves, the users acting as advertising hosts. A system such as this can be used effectively to present passive advertisements to persons out in the community and in some position to act on or respond to the advertising.

### SUMMARY OF THE INVENTION

A problem stated above is that it is desirable for an advertiser to be able to electronically advertise brand, logo, or other advertising to an audience, but many of the conventional means for electronic advertising, such as email advertising, pop-up advertising, and conventional Web page banner advertising tends to irritate many users who may look for ways to avoid seeing the ads when they interact on the network. The inventors therefore considered functional elements of a Web-based advertising system, looking for elements that combined with a unique display device could potentially be harnessed to provide passive advertising but in a manner that would not create animosity on the part of a user receiving and displaying the ads.

Every advertising system seeks to solicit ad response in sufficient number to justify the costs of the campaign. Many systems for delivering electronic advertising employ an ad server to serve advertisements into data accessed by a browser according to some trigger event such as a mouse over or click on a link. The actual ads are viewable only by the person that caused the ad to be displayed.

The present inventor realized in an inventive moment that if, at the point of advertisement display on the accessing device, the ads could be viewable to an audience other than the person invoking the advertising significant improvement in ad response might result. The inventor therefore constructed a unique passive advertising system for network based advertising that allowed advertisements to display on a device connectable to a computing device in a way that makes the ads highly visible to an audience in line-of-sight proximity of the user whom is an ad host instead of an ad target.

Accordingly, the inventor provides a system for passive display of advertisements served from a network. The system includes a computing device having a processor and memory connected to the network a primary graphics display screen on the computing device, and a secondary graphics display screen connected to a port on the computing device, the secondary display screen dedicated for displaying the advertisements. The system is characterized in that the advertisements are served to the computing device along with other network data downloaded for primary display by the device as a result of network activity by the computing device and wherein the advertisements served are displayed on the secondary graphics display screen and not on the primary graphics display screen.

According to another aspect of the invention, the inventor provides a method for conducting a passive advertising business over a network. The method includes the steps (a) soliciting advertisers to provide electronic advertisements for service to end computing devices, (b) soliciting one or more network service venues to accept the advertisements served through their network access points, (c) at each venue, soliciting patrons having end devices capable of navigating the network to host the advertising, and (d) providing secondary display screens, the display screens installable by porting to the end computing devices to patrons who agree to host advertising, the secondary display screens for displaying the advertising.

According to another aspect of the invention, the inventor provides a display device dedicated for displaying electronic advertisements. The display device includes a graphics display screen for displaying graphic and text advertising, an interface for establishing connectivity of the display screen to a host computing device to receive advertisements for display. The display device is characterized in that advertisements downloaded from a network source by the computing device are isolated on the device from the data for primary display and rerouted through the interface for display on the graphics display screen.

According to another aspect of the invention, the inventor provides a method for causing advertisement data included with data received from a network node by a computing device having a primary and secondary display screen to display on the secondary display screen. The method includes the steps (a) tagging the advertisement data for secondary screen display at or before loading the network node with the data to be downloaded, the tag associated with an ad display script included in the download, (b) providing a scanner on the computing device for scanning the data received from the network node, (c) identifying at the time of download of the data, the advertisement data tagged for display on the secondary display screen and the display script, and (d) sending the advertisement data to the secondary display screen according to the ad display script.

According to another aspect of the invention, the inventor provides a notebook computer for displaying passive advertising. The notebook computer includes a processor a with memory, a primary display screen, a secondary display screen for displaying advertising, and an interface for establishing connectivity to the secondary interface.

### BRIEF DESCRIPTION OF THE DRAWING FIGURES

FIG. 1 is an architectural overview of an ad delivery network supporting passive advertising according to an embodiment of the present invention.

FIG. 2 is a rear elevation view of a notebook computer supporting a peripheral display screen for displaying advertisements according to an embodiment of the present invention.

FIG. 3 is a block diagram illustrating a module for sorting advertisements for secondary display and for logging the activity according to an embodiment of the present invention.

FIG. 4 is a block diagram illustrating a business model between advertisers, an advertisement service, and advertisement venues according to an embodiment of the present invention.

### DETAILED DESCRIPTION

The invention conceived and provided is an advertising system and apparatus and includes a method for delivering and displaying the advertising. The system and apparatus as well as methods for conducting passive advertising are described in enabling detail in various embodiments below.

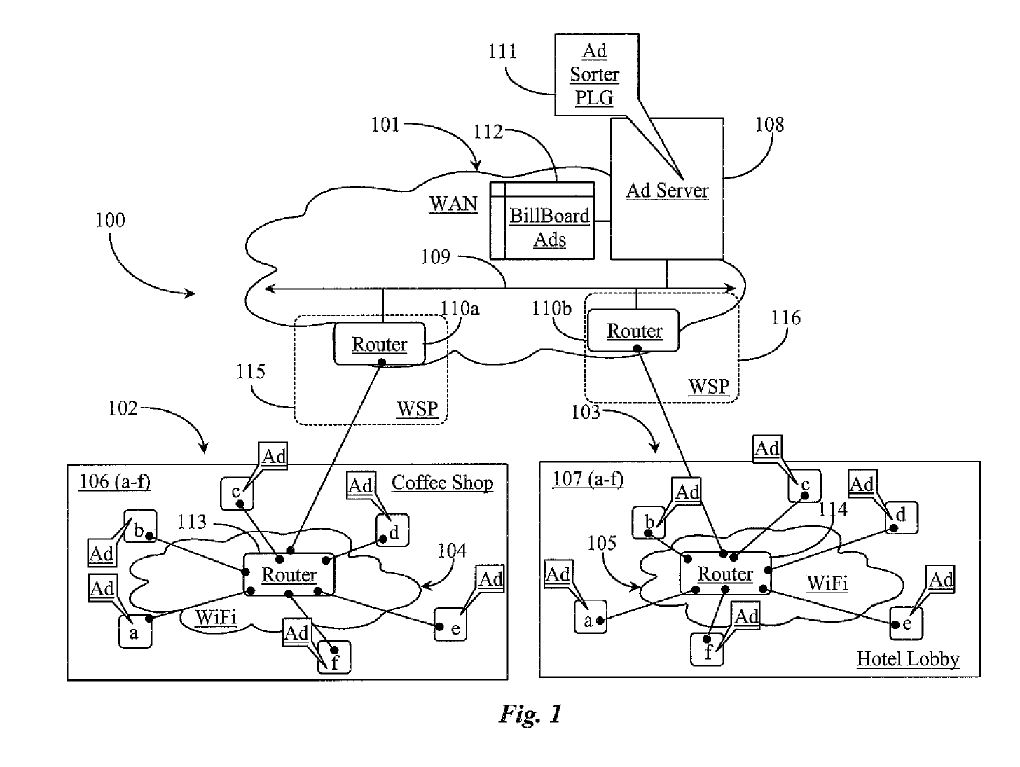

FIG. 1 is an architectural overview of an ad delivery network supporting passive advertising according to an embodiment of the present invention. Referring now to FIG. 1, an advertising system 100 includes at least one adverting server 108 connected to a wide area network (WAN) 101. Ad server 108 serves electronic advertisements to consumers through Web pages the consumers select by navigating the Internet. System 100 includes consumer-computing stations or devices 106 (a-f) illustrated as gathered at a wireless fidelity (WiFi) location or “hot spot” 102. System 100 also includes like computing stations or devices 107 (a-f) gathered at another WiFi hot spot 103. WiFi hot sport 102, in this example is a coffee shop such as the popular venue Starbucks™. WiFi hotspot 103 is a hotel lobby in this example. There are a growing number of localized wireless hot spots, including municipal area networks (MAN) that cover larger municipal regions offering free or subscriber Internet access services. In one embodiment, the computing stations 106 (a-f) and 107 (a-f) are laptop or notebook computers accessing the Internet network through a WiFi hot spot like hot spot 102 or hot spot 103. In one embodiment the computer stations or devices may be a mix of notebook computers and other computing devices having a primary display like a personal digital assistant (PDA), smart phone, or cellular telephones with network navigation capability.

Computer stations 106 (a-f) and 107 (a-f) are adapted through a peripheral display apparatus (illustrated later in this specification)) for receiving advertisements served by ad server 108. System 100 also includes software (SW) 111 available, in this example as a SW browser plug-in from Ad server 108. SW 111 may be distributed to all of computer stations 106 (a-f) and to all of stations 107 (a-f). When distributed to and running on end computer stations, SW 111 performs advertisement sorting from downloaded graphics and text and provides instruction and enabling code for displaying the advertisements on the peripheral display apparatus.

WAN 101 is, in a preferred embodiment, the public Internet network and is exemplified by an Internet backbone 109 extending there through. Backbone 109 represents all of the existing lines equipment and access points that make up the Internet as a whole. Therefore, there are no geographic limits to the practice of the invention.

Ad server 108 includes a data repository 112 for storing ads for service according to an embodiment of the present invention. In one embodiment, the ads that are served to end computer stations 106 (a-f) and 107 (a-f) are billboard type ads that are visually recognizable like popular brand logos and graphics that may be linked to a company or product. In this embodiment there is little or no text and little or no animation. The ads in repository 112 are in a preferred embodiment, designed for instant visual recognition by consumers.

In one embodiment, the advertisements in repository 112 are iconic billboard type advertisements having a logo and, in some cases, contact information like a telephone number, web address, email, etc. The ads are, in a preferred embodiment silent display ads or billboard type ads that rotate replacing one advertisement with another advertisement display after a certain period of time. The ads are all displayed on a peripheral display device that may be part of or otherwise connected to an end computing station, which in this example is a notebook or laptop with a flip open top. In other embodiments other computing devices may be used so long as they are capable of connecting to and navigating the network and have a primary display screen.

In this example, there is a wireless router in each hot spot. Router 113 is resident in hot spot 102 and router 114 is resident in hot spot 103. Router 113 connects wirelessly or by wire to a router 110a maintained by a wireless service provider (WSP). Likewise, router 114 connects wirelessly or by wire to a router 110b maintained by a WSP 116. Both routers 110a and 110b are connected to backbone 109 in network 101.

Router 113 has a wireless connection range represented herein by a WiFi network cloud 104. Router 114 has a wireless connection range represented herein by a WiFi network cloud 105. It will be appreciated by one with skill in the art of wireless networking that there may be more than one router and that the exact range of a single router may vary according to the design of the router. In some cases, WiFi range extends well beyond the immediate premises of the hot spot.

Ad server 108 may be owned by a third party service that sells advertisement space to businesses. As part of a business method governed by service contract or other agreement, the host of ad server 108 has a business relationship with the owner/operator of each supported hot spot. Each owner/operator of each hot spot in turn has a special business relationship with each patron that agrees to accept advertisements on his or her computing station.

According to a business method, the ad space for sale is the area covering the back of the notebook screen on a typical flip-top laptop or notebook computer. The advertising area is enabled to display billboard ads through provision of a flexible computer screen provided in one embodiment using a polymer light-emitting diode (PLED) technology or display screen technology such as organic light emitting diode (OLED). In a preferred embodiment, PLED technology is used. The flexible computer screen is a secondary display screen that may be attached to a laptop by securing it to the back of the laptop monitor and plugging it into a port on the laptop such as a serial port, a universal serial port (USB), an IEEE interface, a VGA interface, or some other port that may transfer graphics from the computer cache to the peripheral display device. The peripheral display device is described in detail later in this specification.

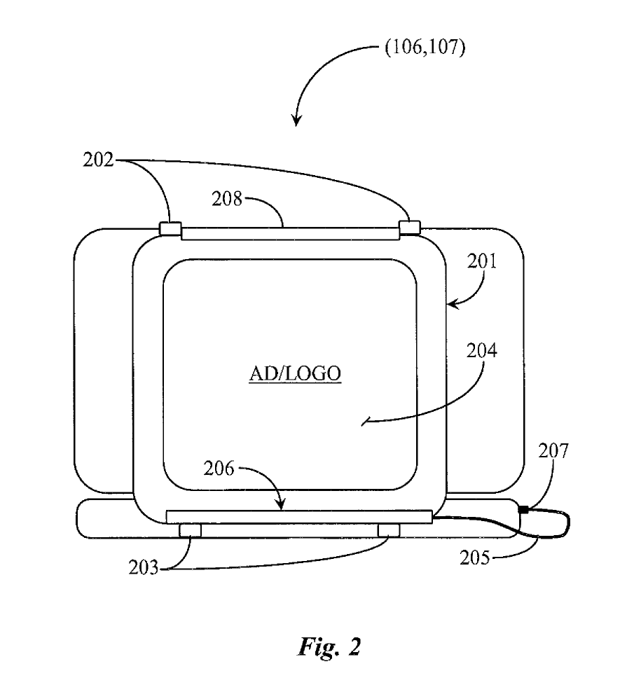

FIG. 2 is a rear elevation view of a notebook computer 208 supporting a peripheral display screen 201 for displaying advertisements according to an embodiment of the present invention. Referring now to FIG. 2, an end computer station analogous to stations 106 (a-f) or 107 (a-f) is illustrated with a peripheral display device (PDD) 201 attached to the back of the notebook or laptop primary display screen. Peripheral device 201 is, in a preferred embodiment, an inexpensive PLED display device that includes connection circuitry for receiving power from the computing station and an interface 207 and cable 205 for accessing the host computer. In one embodiment, interface 207 is a USB interface and cable 205 is a USB cable.

PLED screen 201 is flexible and may come rolled up for convenience. Device 201 has snap hooks 202 for securing the top portion of the screen to the computer top and snap hooks 203 for securing the device to the bottom or base of the computer. A thin base housing 206 is provided on device 201 to house required circuitry for accepting ads for display. The actual display area 204 is where ads/logos are displayed.

Referring now back to FIG. 1, any one or all of computer stations 106 (a-f) and 107 (a-f) may be have a PLED screen 201 of FIG. 2 attached and displaying an Ad for purposes of discussion. It is noted herein that the ads delivered to patrons of hot spot 103 may be different than those delivered to hot spot 102. Likewise all of the ads delivered to one hot spot do not necessarily display on all of the connected laptop peripheral devices at the same time or in the same rotation order. Further all connected computers may not be running advertisements while they are connected.

In one embodiment according to a business method, peripheral display device 201 of FIG. 2 is a peripherally attachable PLED display screen physically provided to willing patrons by the entity hosting the local WiFi network capability. For example, a number of peripheral display devices may be made available to patrons that come in with their computers to access the Internet while they patronize the business or location of the hot spot. In other words, the PLED screens may be kept at the venue location such as at the counter, and may loaned to patrons who agree to sell the advertising space on the back of their computers while at the venue.

The display screen is attachable to any laptop or notebook screen by using polymer snap hooks 202 and 203 or some other connector to attach the top of the flexible screen to the top rear edge of the flip open screen of the notebook or laptop such that the display screen may be rolled out or otherwise be caused to cover the entire back surface of the screen of the laptop or notebook or at least a visible portion of the area. The user operating the laptop may plug in the PLED screen using one of several acceptable ports on the computer like a USB port, for example.

When a patron comes into an establishment or otherwise patronizes an entity hosting the hot spot to access the Internet, he or she is solicited to sell the space of the back of their computing station for some incentive. For example, at Starbucks™, the Internet access may be provided free to those patrons willing to display ads while they are browsing or performing other mundane online tasks such as answering emails. Perhaps the incentive is free coffee.

SW 111 running on end computing stations 106 (a-f) and 107 (a-f) recognizes the secondary PLED screen device 201 of FIG. 2 and delivers the billboard advertisements to the PLED screen instead of displaying them on the primary computer screen. The advertisements are delivered by one or more servers like server 108 into the data stream downloaded by the receiving station as they are accessing the Internet while downloading email, browsing Web pages, or otherwise connected to the network, in a preferred embodiment, through the WiFi router.

The advertising sources may be Web based servers that are activated when a user has logged on to the WiFi network. In this case, end users are identified for receiving ads as the user navigates the Internet, the iconic or billboard advertisements are downloaded with the data that will display on the primary screen, but the ads themselves display on the “back screen” so that persons walking though the venue may see the advertisements. The person receiving the advertisements at his or her end computing station is not the target of the advertisements and does not see them, rather, the targets are persons walking though the venue or sitting across from or in a position relative to the end station so that they can view the advertisements.

Although this example refers to a peripheral secondary display device that is mounted to a notebook computing device, the display plugged into an external port on the device, the exact arrangement presented here is not specifically required to practice the present invention. In one embodiment the peripheral display device may stand apart from the connected host computing device like a display stand and may be positioned on a table next to the computing station. In this embodiment the computing device may be a cell phone, a smart phone, a PDA or some other device capable of connecting to and navigating the network. In one embodiment, the peripheral display device may be battery powered and may not require any power from a host device. Likewise, the advertisement data destined for secondary display downloaded to the host device may be transferred wirelessly from the host device to the peripheral display screen using Bluetooth or some other wireless method.

In the present embodiment, the inventor provides device 201 in a form that can be mounted to the back of a notebook computer for convenience and that the actual advertising is displayed away from the host toward onlookers or passersby such as those patrons normally doing business at the venue but not necessarily there to connect to network services provided at the venue.

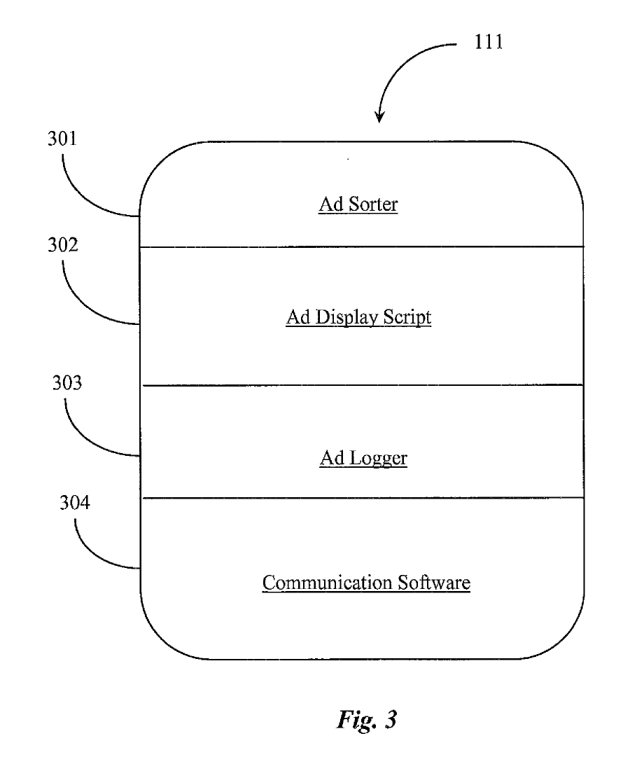

FIG. 3 is a block diagram illustrating a module 111 for sorting advertisements for secondary display and for logging the activity according to an embodiment of the present invention. Referring now to FIG. 3, SW 111 may reside on an end computing station like stations 106 (a-f) or 107 (a-f) described above. SW 111 may be provided as a downloaded install or as an upload and install from a removable media like a CD-ROM for example.

SW 111 includes am Ad sorter 301 for sorting the participating advertisements from regular Web-based graphics and text that will display on the primary screen. A method for tagging ads for secondary display may be practiced by the entity that serves the advertisements. The ad sorter is capable of reading those tags and separating the participating ads from the other data in the data stream.

SW 111 includes a dynamic ad display script 302. Script 302 contains instruction and code for displaying multiple ads in a rotating sequence for specific periods of time.

In one embodiment a pool of advertisers has reserved space and time for ad display. When a user connects online and plugs in the peripheral display screen, the ad server may update SW 111 with a new ad display script that references all of the current advertisements in the pool for display and provides specific instructions for each ad in the pool as to how long it will appear on screen before the next ad in the lineup displays.

In one embodiment, ads that normally appear in Web pages accessed by a user may also be candidates for secondary display on the peripheral ad screen. In this embodiment, the tags may be embedded into the static Web-page ads that normally appear. In one case those exact ads may appear in the primary screen and on the secondary screen in the specified rotation sequence. In another case, those ads may have an embedded tag and a link to the billboard version of that ad on the same or on another server. The user's browser may then fetch the ad and display it on the peripheral “ad” screen. The billboard version of the ad will not display on the primary monitor.

SW 111 includes an ad display logger that keeps a record of what ads displayed how many occurrences of display of those ads, and the total time of the online session. The ad logger serves to inform the entity that is being compensated by the advertisers of the statistics compiled for ad display on each of the end computer stations for each participating hot spot. In this way accounting may be performed and proper invoicing for the advertisement service can be rendered. It is important to note herein that an advertiser may be solicited for placing ads at one a combination of or all of the available participating hot spots. The advertiser may determine that a particular hot spot is best for the specific ad or ads the advertiser wants to run.

The advertising scheme in this embodiment is a passive advertising scheme that serves to promote awareness of the company and the services and products of the company fresh in the consumers mind while the consumer is patronizing a hot spot location.

SW 111 has a communication software extension 304 provided thereto. Communication software extension 304 enables automatic reporting of ad statistics to the entity managing or providing the ad service. The information provided may include the identification of the patron running the ads, the identification of the ads, the time spent running the ads and like information that enables the entity to tally the statistics for billing and, in one embodiment, for reward purposes. For example, a patron may be solicited to sell advertising space for immediate benefits like free coffee while running ads. In addition, the amount of time the user spends running ads may be considered in a point-based system wherein the patron can earn points toward gifts, vacations, and so on. There are many possibilities.

### Business Method:

A good example might be advertising at the popular venue “Starbucks”. A user may pick up a PLED peripheral display screen like device 201 of FIG. 2 at the counter and may attach the screen to the back of his laptop flip screen and then plug it in. Now when the user connects through the WiFi access point to the network, any advertisements that the venue “Starbucks” has solicited and approved for display from various advertisers competing for the space begin displaying on the back of the users notebook or laptop for others to view. In a preferred embodiment, the ads are simple visual ads and do not have audio. Popular brands like Coca-Cola, Nike, Google, and so on may advertise at the venue as well as other competing brands.

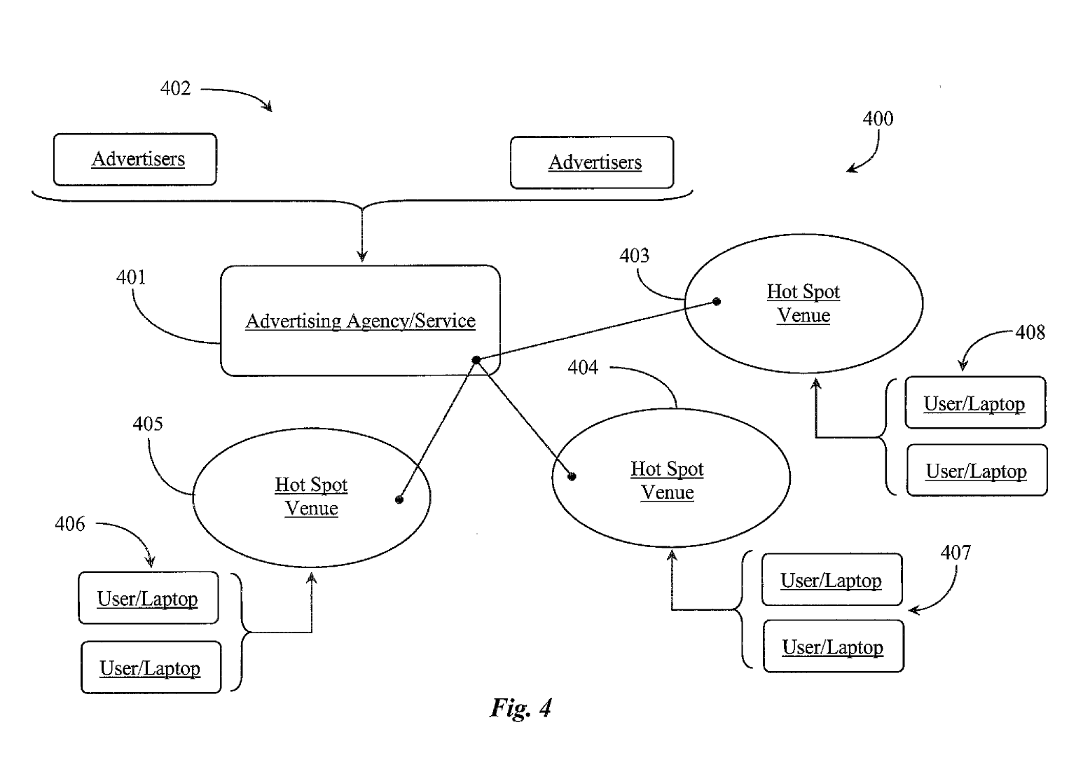

FIG. 4 is a block diagram illustrating a business model 400 between advertisers 402, an advertisement service 401, and advertisement venues 403-405 according to an embodiment of the present invention. Referring now to FIG. 4, a business model 400 includes an advertisement agency or ad placement service 401. Service 401 is a third-party service that solicits advertisement contracts from advertisers 402. Service 401 is not absolutely required to practice the present invention. A service is illustrated as a convenience so that each venue does not have to solicit ads directly from advertisers.

Advertising service 401 has a business relationship with each hot spot venue, in this example, venue 403, venue 404, and venue 405. The business relationship defined one where the agency sells virtual ad space for each venue to advertisers. The advertisers 402 in turn agree to advertise with one or more venues through the agency for a fee paid to agency 401.

Each venue (403-405) solicits ad space from their patrons illustrated herein as patrons 408 for venue 403, patrons 407 for venue 404, and patrons 406 for venue 405. This solicitation is defined as notifying all patrons, generally defined as a user with a network capable Laptop that if they agree to accept advertising using the ad display screen of the invention, then they can receive certain benefits or other forms of compensation accordingly. This ongoing solicitation may result in any number of patrons willing to participate at different times. For example, the exact number of participating patrons may vary from time to time as ad delivery only occurs when those patrons are online at the venue. Demographics, including location of the venue may play a large role in the types of advertisers that are attracted to the venue and the amount of compensation those advertisers will pay for ad delivery and placement at specific venues.

In an embodiment using ad agency 401, the agency may maintain its own ad servers that deliver ads to the patrons at each venue. Each venue may play a role in approving or disapproving certain advertisements for display on patron's laptops. The ad agency compensates each venue for allowing advertisements to be placed at that venue. In turn, each venue may compensate patrons for agreeing to sell ad space for ad display.

As previously described, the agency 401 can pull together a popular advertising campaign for any advertiser based on demographics, location and timing. For example, a wireless venue like a Starbucks™ situated in a popular shopping mall may rate especially high for an advertiser that has a retail outlet in the same mall. The brand advertisement placed on one or more ad screens can remind persons that see the ad that the product is available in the same mall, perhaps a shoe store next to the venue for example.

On the consumer side, the business method involves soliciting the consumer who has brought his or her computer into the venue for the purpose of connecting to the network for the available ad space on the back of the laptop or notebook. In exchange, the user or patron may get a free connection to the network where other patrons' not receiving ads have to pay for the time. In one embodiment, where the WiFi connection is free to the user, the WiFi host, usually the venue maintaining the access point, may offer some free services like free coffee, or the like. The advertisers pay the WiFi host through the ad agency, or directly in the case of no third part agency, for getting their billboard ads onto the backs of the patron's computers.

In one embodiment of the invention, an ad server is donated to each participating venue that signs up for the service. In this embodiment, each patron that connects to the local router at the venue is checked to determine the presence of the secondary display screen. Those that have the screen plugged in are identified as ad recipients and ads from the ad server are delivered to those end users.

The mechanics of ad service may be implemented through any acceptable port that the user connects through. Web data and ad data are, in a preferred embodiment, served together. Software on the computer receiving the advertisement sorts the billboard ads for secondary display. Identification of the ads for secondary screen display may be accomplished through simple data tagging techniques.

The actual software that sorts the ads may be a very small program that may be downloaded when the user logs into the network and accesses a Website service with the screen attached. The technology for maintaining the second display may be accomplished by any monitor out program with the addition of graphics selection capabilities for remote display.

The business concept is that the ads are visible to persons other than the user receiving the ads. This can be a very popular means of advertising if deployed in very popular venues like Starbucks™ where there are many worldwide locations and a lot of through traffic.

Referring now back to FIG. 4, it may be important for advertisers to place timely ads that are relevant to the types of patrons visiting the venue. In one example, a venue might be a Starbucks™ in an international airport. Many of the people that will see the advertisements at that venue will be flyers or family and friends of flyers from various parts of the world. Therefore, ads solicited for this venue may also be international advertisements from advertisers having locations near the venue like hotels, rental services and the like, and perhaps advertisers from other countries offering discount travel packages, vacation spots, and the like. As well, advertisers maintaining shops at the airport may compete to place ads at the venue. The patrons may enjoy free coffee, food or other amenities. Moreover, service-logging capabilities may be used to tally points earned by patrons who use the system quite often. Patrons can compete for prizes, cash, trips, free air miles, and so on.

In one embodiment of the present invention, global positioning satellite (GPS) technology can be used with wireless patrons to enhance service in some cases. GPS is available on some wireless devices and can be provided with most types of wireless cards that computers use. Combining this capability with a mapping service may provide participating patrons with local maps to the most popular wireless venues in the area that they may visit to display advertising. The venues may compete with one another by publishing in advance the compensation they are willing to give patrons that display ads in those venues. In a large metropolitan area, there may be many local hot spots participating with the service. The actual advertisements may vary in each of the hot spots as demographics and location considerations play out for advertising campaigns.

Passive advertising according to the business model described in this specification can be practiced in any venue or “hot spot” where network access is offered free or on a subscription basis. Patrons of such venues may be engaging in any network activity while advertisements are delivered to their computing devices for dedicated display on a peripheral advertisement display device connected to the host computing device. In one embodiment, users are not required to navigate Web pages in a traditional sense to receive the advertisements. Advertisements may be inserted into any network download data or data stream the user may be receiving such as with texting, chatting, downloading email, downloading music, video, or photographs, or the like. Ad data may also be delivered to a computing device while it is idle (connected but not purposely sending or receiving data); or when the patron is actively uploading data.

What is claimed is:

1. A system for passive display of advertisements served from a network comprising:
a computing device having a processor, a memory and a primary display screen, connected to the network; and
a secondary graphics display screen connected to a port on the computing device, the secondary screen deployable at a position different than the primary screen;
characterized in that the advertisements are served to the computing device along with other network data downloaded for primary display by the device as a result of network activity by the computing device and the advertisements are displayed on the secondary graphics display screen and not on the primary graphics display screen.

2. A method for conducting a passive advertising business over a network comprising:
(a) soliciting advertisers to provide electronic advertisements for service to end computing devices;
(b) soliciting one or more network service venues to accept the advertisements served through their network access points;
(c) at each venue, soliciting patrons having devices capable of navigating the network to host the advertising; and
(d) providing secondary display screens, the display screens installable by porting to the computing devices to patrons who agree to host advertising, the secondary display screens for displaying the advertising.

3. A display device dedicated for displaying electronic advertisements comprising:
a graphics display screen for displaying graphic and text advertising; and
an interface for establishing connectivity of the display screen to a host computing device to receive advertisements for display;
characterized in that advertisements downloaded from a network source by the computing device are isolated on the device from the data for primary display and rerouted through the interface for display on the graphics display screen.

4. A method for causing advertisement data included with data received from a network node by a computing device having a primary and secondary display screen to display on the secondary display screen comprising:
(a) tagging the advertisement data for secondary screen display at or before loading the network node with the data to be downloaded, the tag associated with an ad display script included in the download;
(b) providing a scanner on the computing device for scanning the data received from the network node;
(c) identifying at the time of download of the data, the advertisement data tagged for display on the secondary display screen and the display script; and
(d) sending the advertisement data to the secondary display screen according to the ad display script.

5. A notebook computer for displaying passive advertising comprising:
a processor a with memory;
a primary display screen;
a secondary display screen for displaying advertising; and
an interface for establishing connectivity to the secondary interface.
